(19) United States
(12) Patent Application Publication
(10) Pub. No.: US 2024/0362859 A1
(43) Pub. Date: Oct. 31, 2024

(54) SYSTEMS, METHODS, AND DEVICES TO GENERATE INTERACTIVE VIRTUAL ENVIRONMENTS

(71) Applicant: OBSESS, INC., New York, NY (US)

(72) Inventors: Neha Singh, New York, NY (US); John Mann, New York, NY (US); Hiran Gnanapragasam, New York, NY (US)

(73) Assignee: OBSESS, INC., New York, NY (US)

(21) Appl. No.: 18/646,351

(22) Filed: Apr. 25, 2024

Related U.S. Application Data
(60) Provisional application No. 63/461,644, filed on Apr. 25, 2023.

(51) Int. Cl. G06T 17/00; G06F 3/0486; G06Q 30/0601

(52) U.S. Cl. CPC G06T 17/00; G06F 3/0486; G06Q 30/0643

(57) ABSTRACT

Systems, methods, and devices provide virtual, three-dimensional, interactive environments with multiple customization layers. A virtual environment platform provides an environment generator engine for generating a computer-generated three-dimensional (3D) space by rendering 3D model and applying one or more surface customizations to the 3D model. Additionally, product models are mapped to one or more virtual surfaces of the 3D model. An avatar customization engine generates a virtual avatar navigable in the computer-generated 3D space. Moreover, the avatar customization engine defines a first set of customization parameters as mutable and a second set of customization parameters as immutable. The system also causes the virtual interactive environment to be presented, at a display of a user device, and receives user input(s) controlling the virtual avatar and selecting at least one product model of the one or more product models. In response, the system presents data associated with the product model.

### CROSS-REFERENCE TO RELATED APPLICATIONS

The present application claims priority to U.S. Provisional Patent Application No. 63/461,644 filed on Apr. 25, 2023, which is incorporated by reference in its entirety herein.

### FIELD

Aspects of the presently disclosed technology relate generally to systems and methods for generating interactive three-dimensional virtual environments for product interaction and virtual experience and more particularly to an interactive environment using three-dimensional modeling.

### BACKGROUND

Many retailers would like to present their own, custom, virtual store on their own site. However, engaging virtual environments with sophisticated browsing and shopping features are difficult to build. Cost constraints can prevent many retailers from investing in developing their own virtual stores in-house. E-commerce sites typically use a scrollable list of images and drop-down browsing structure with little focus on recreating the nuances of a brick-and-mortar shopping experience. Furthermore, it can be difficult to match the features and styles of an interactive environment to a particular brand while keeping the environments updated and engaging as companies grow and change.

It is with these observations in mind, among others, that various aspects of the present disclosure were conceived and developed.

### SUMMARY

Implementations described and claimed herein address the foregoing problems by providing systems and methods for providing a virtual interactive environment. For instance, a method to provide a virtual interactive environment can include providing, with an environment generator engine, a computer-generated three-dimensional (3D) space by rendering a 3D model and applying one or more of a lighting source layer, a reflective material layer, or a texture layer to the 3D model. The method can also include providing one or more product models mapped to one or more virtual surfaces of the computer-generated 3D space; and/or generating, with an avatar customization engine, a virtual avatar navigable in the computer-generated 3D space, the avatar customization engine defining a first set of customization parameters selected to be mutable and a second set of customization parameters selected to be immutable. Furthermore, the method can include causing the virtual interactive environment to be presented, at a display, as the virtual avatar navigable in the computer-generated 3D space; receiving user input controlling the virtual avatar and selecting at least one product model of the one or more product models; and/or presenting, at the display, data associated with the at least one product model.

In some instances, the method further includes presenting an environment creator user interface (UI) at the display. Providing the one or more product models can include providing a one or more 3D mapping coordinates corresponding to virtual surfaces of the 3D model; and/or receiving, at the environment creator UI, a selection of the one or more 3D mapping coordinates to designate locations for the one or more product models. Additionally, receiving the selection of the one or more locations can include receiving a drag-and-drop input placing the one or more product models at the one or more 3D mapping coordinates. The environment creator UI can also include a graphical interactive feature for toggling between a high resolution output and a low resolution output, and, in response to receiving a toggle input at the graphical interactive feature, the method can further include converting the 3D model into a plurality of cube maps corresponding to a plurality of viewpoints; and/or providing the computer-generated three-dimensional (3D) space by rendering the plurality of cube maps instead of rendering at least a portion of the 3D model.

In some examples, providing the computer-generated 3D space includes applying the reflective material layer to the 3D model. Moreover, the method can include providing an environment boundary shape, at least partially enclosing the 3D model, to create a sky visualization or a ceiling visualization with a surface of the environment boundary shape. The reflective material layer can create a reflection of the surface viewable from a perspective of the virtual avatar. Additionally or alternatively, the second set of customization parameters can be selected to be immutable based on style parameters associated with a type of merchant entity. For instance, the second set of customization parameters selected to be immutable include one or more of a body shape or a degree of realism (e.g., based on the type of merchant being a clothing merchant, a cosmetic merchant, or a jewelry merchant). The method can also include establishing a multi-user session in the virtual interactive environment; and/or generating an invite link associated with the multi-user session for providing access to the multi-user session for a plurality of users. Moreover, the method can include presenting an option, responsive to the user input selecting the at least one product model in the multi-user session, for the plurality of users to add an item corresponding to the at least one product model to accounts associated with the plurality of users. By way of example, the method can also comprise presenting an option to at least one user of the plurality of the users to switch between viewing a primary user navigating the computer-generated 3D space or navigating the computer-generated 3D space independent of the primary user.

In some instances, a system for providing a virtual interactive environment includes one or more processors; and a computer-readable memory device storing instructions that, when executed by the one or more processors, cause the system to perform various operations, such as providing an environment generator engine for generating a computer-generated 3D space by rendering a 3D model and applying one or more surface customizations to the 3D model. The instructions can also cause the system to provide one or more product models mapped to one or more virtual surfaces of the 3D model; provide an avatar customization engine for generating a virtual avatar navigable in the computer-generated 3D space, the avatar customization engine defining a first set of customization parameters selected to be mutable and a second set of customization parameters selected to be immutable; and/or cause the virtual interactive environment to be presented, at a display of a user device, as the virtual avatar navigable in the computer-generated 3D space. Moreover, the instructions can cause the system to receive user input controlling the virtual avatar and selecting at least one product model of the one or more product models; and/or present, at the display, data associated with the at least one product model.

In some instances, the system provides a gamification engine for layering a scavenger hunt type game or a tile matching type game into the computer-generated 3D space. Moreover, the display can be a first display, and providing the environment generator engine can include presenting an environment creator UI at second display of a merchant device. The environment creator UI can receive one or more inputs indicating at least one of: a location of the one or more product models in the computer-generated 3D space; a personalization of at least a portion of the computer-generated 3D space for a particular user; a customized message in the computer-generated 3D space; or a lighting theme for a portion of the computer-generated 3D space. Furthermore, the first set of customization parameters can be mutable and the second set of customization parameters can be immutable based on an avatar profile template associated with the merchant device.

In some examples, the avatar profile template is a first avatar profile template and the merchant device is a first merchant device of a first merchant entity; and/or the instructions, when executed by the one or more processors, further cause the system to provide the avatar customization engine to a second merchant device corresponding to a second merchant entity, the avatar customization engine defining a third set of customization parameters selected to be mutable and a fourth set of customization parameters selected to be immutable. Additionally, the fourth set of customization parameters selected to be immutable can correspond to a second avatar profile template associated with the second merchant entity, and the fourth set of customization parameters selected to be immutable can be different than the second set of customization parameters selected to be immutable. By way of examples, the one or more surface customizations include at least one of a lighting source layer, a reflective material layer, or a texture layer. Also, the environment generator engine can generate the computer-generated 3D space by rendering one or more cube maps, based on the 3D model, in addition to rendering the 3D model. Moreover, the instructions, when executed by the one or more processors, can cause the system to present a graphical interactive element which, upon receiving a user input, establishes a multi-user session for the virtual interactive environment. The multi-user session can include an audio channel for receiving an audio signal as input at a first user device corresponding with primary user; and/or sending the audio signal as output at a plurality of user devices corresponding with a plurality of secondary users.

In some instances, a method to provide a virtual interactive environment includes providing, with an environment generator engine, a computer-generated 3D space by rendering a 3D model and applying one or more of a lighting source layer, a reflective material layer, or a texture layer to the 3D model. The method can also include providing a creator user interface (UI) for mapping one or more product models to one or more virtual surfaces of the 3D model; providing an avatar customization UI for generating, with an avatar customization engine, a virtual avatar navigable in the computer-generated 3D space; and/or causing the virtual interactive environment to be presented, at a display of a user device, as the virtual avatar navigable in the computer-generated 3D space. Additionally or alternatively, the method includes receiving user input controlling the virtual avatar and selecting at least one product model of the one or more product models; and/or presenting, at the display, data associated with the at least one product model. Furthermore, the avatar customization engine can define a first set of customization parameters selected to be mutable and a second set of customization parameters selected to be immutable.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system for generating a computer-generated 3D space with a virtual environment platform.

FIG. 2 illustrates an example system for providing a virtual environment platform to a merchant system and a guest system, which can form at least a portion of the system of FIG. 1.

FIG. 3 illustrates an example system for generating a computer-generated 3D space using an environment generator engine, which can form at least a portion of the system of FIG. 1.

FIG. 4 illustrates an example system for generating a computer-generated 3D space using a multi-user session manager, which can form at least a portion of the system of FIG. 1.

FIG. 5 illustrates an example system for generating a computer-generated 3D space using a gamification engine, which can form at least a portion of the system of FIG. 1.

FIG. 6 illustrates an example system for generating a virtual interactive environment using one more computing systems, which can form at least a portion of the system of FIG. 1.

FIG. 7 illustrates an example method for providing a computer-generated 3D space with the virtual environment platform, which can be performed by the system of FIG. 1.

### DETAILED DESCRIPTION

Aspects of the present disclosure involve systems, methods, and devices for generating a virtual interactive environment that can be navigated by various avatars belonging to a plurality of users. Using the techniques discussed herein, a virtual environment platform can provide customized virtual environments to a number of different merchant systems. The merchant systems can, in turn, control some aspects of the virtual environment, such as setting selectable parameters for the avatars created by the guests. Certain parameters of the avatars and other aspects of the virtual environment (e.g., friend mode parameters or gamification parameters) can be set as immutable as provided to the merchant system, or the merchant system can control these parameters. As such, the virtual environment platform can seamlessly integrate different types of data and file types representing different aspects of the virtual world that results in an engaging user experience unique to and customized for a particular entity or brand.

Additionally, a friend service (e.g., a multi-user session) can present the interactive virtual environment to multiple user devices simultaneously while facilitating a video conference to provide a shared interactive experience. The friend service can include audio streaming, screen sharing, synced carts, specialized features/environment interactions, multi-casting, messaging services, and various other services to share information of the interactive environment the between the multiple devices. This service can be used by celebrities, influencers, personal stylists, friend groups, families, or anyone with an audience to view or share the interactive experience.

Any type of 3D model can be used for generating the virtual environment, increasing the customization varieties of the interactive virtual environments that can be generated. Moreover, an environment generator engine can integrate with multiple different types of merchant platforms (e.g., via an API integration process) to provide updated product information in the virtual environment, for instance, on a daily basis. As such, the virtual environment can be hosted by a merchant entity site and/or integrate with any platform to provide an accurate depiction of the product offerings for the merchant in a more engaging environment than typical ecommerce sites.

These techniques increase the efficiency of data storage and retrieval processes to create the virtual interactive environment, reduce the lag time for rendering the virtual interactive environment, and maintain a high resolution. Moreover, the different layers of parameter control provided at the platform level, the merchant level, or the guest system level—and the ability to change the level at which a parameter is mutable or immutable—can provide uniquely customized environments for a wide variety of different entities. Different 3D models, avatar profile templates, and product models can be customized for the different merchants to closely tie visual features of the virtual world to the requirements of that particular entity. Additional advantages will become apparent from the disclosure herein.

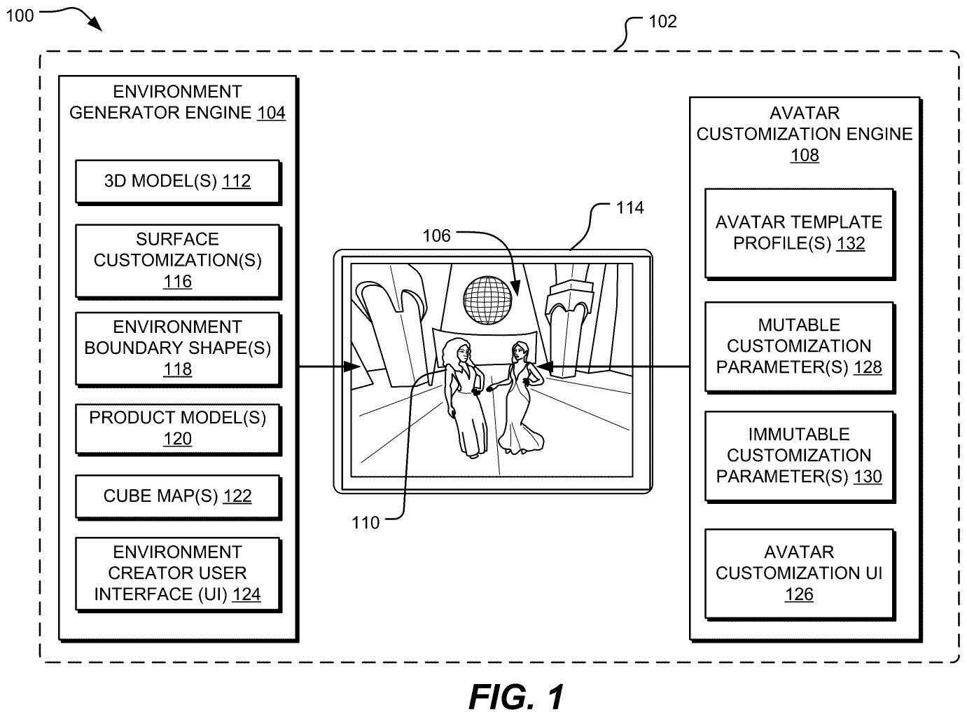

FIG. 1 illustrates an example system 100 including a virtual environment platform 102 for providing a virtual interactive environment. The virtual environment platform 102 can include an environment generator engine 104 to generate a computer-generated 3D space 106 of the virtual interactive environment. Furthermore, the virtual environment platform 102 can include an avatar customization engine 108 for defining customization parameters of avatar(s) 110 navigable in the computer-generated 3D space 106. The virtual environment platform 102 can include various additional features, such as a multi-user session manager or a gamification engine, as discussed in greater detail below.

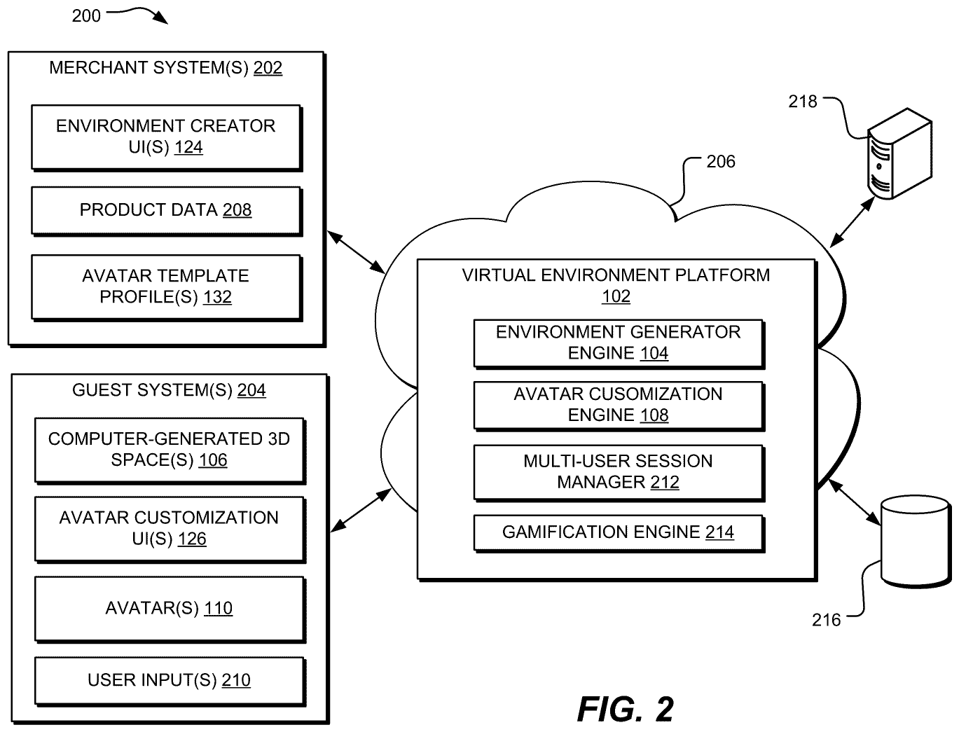

In some examples, the virtual environment platform 102 can receive one or more 3D models 112 to form the computer-generated 3D space 106. The 3D model(s) 112 can include a computer-generated imagery (CGI) 3D model such as, a primitive model, a polygon model, a rational B-Spline model, a Non-Uniform Rational Basis Spline (NURBS) model, a Computer Aided Design (CAD) model, a solid model, a wireframe model, a surface model, combinations thereof, and so forth. The 3D model 112 can be rendered at a display 114 (e.g., of a user device for a guest system, as discussed below regarding FIG. 2) to create the computer-generated 3D space. Moreover, one or more surface customization(s) 116 can be layered over the 3D model 112 to be rendered simultaneously with or after rendering the 3D model 112. The surface customization(s) 116 can include one or more of a light source layer, reflective material layer, a texture layer, combination thereof, and so forth. Additionally or alternatively, the computer-generated 3D space 106 can include an environment boundary shape 118. The environment boundary shape 118 can include a shape or object that is mapped over or around the 3D model 112 such that the environment boundary shape 118 at least partially or fully surrounds the 3D model 112. In this way, the environment boundary shape can form a visualization of an outer boundary portion of the computer generated 3D space 106. For instance, the environment boundary shape 118 can be a sphere surrounding a top portion of the 3D model 112. An interior surface of the sphere can form a visualization of a sky (e.g., a night sky with stars, clouds, the moon, etc.) over the 3D model 112. Additionally or alternatively, the environment boundary shape 118 can be a square, a rectangular prism, a pyramid, and so forth to form an outer boundary visualization such as a ceiling, a roof, and/or the sky.

In some examples, the environment generator engine 104 includes one or more product model(s) 120. The product models 120 can be one or more 2D images or 3D models visually representing the products of the merchant. The product model(s) 120 can be detailed and/or hyper realistic virtual 3D objects to accurately depict fabric, textures, colors, and other visual aspects of the product of interest to potential buyers. The product model(s) 120 can be associated and/or linked to product data corresponding to the product model(s) 120, such that an interaction with the product model 120 causes the system 100 to retrieve and/or present the product data at the display, as discussed in greater detail below. The product model(s) 120 can be mapped to various surfaces of the 3D model 112 (e.g., a wall, a clothes rack, a table, a counter, a display stand, etc.) and/or can render with the 3D model 112 to form the computer-generated interactive 3D space 106. In some scenarios, the environment generator engine 104 detects a current location coordinate associated with the avatar 110 and renders portion(s) of the 3D model 112 and/or product model(s) 120 having location coordinates within a predetermined distance of the current location coordinate of the avatar 110. The environment generator engine 104 can also configure the product models 120 to adjust an angle of presentation to stay facing the avatar 110 as the avatar 110 moves about the computer-generated 3D space 106.

Furthermore, in some instances, the environment generator engine 104 generates and/or uses one or more cube map(s) 122 to form the computer-generated 3D space 106. The cube map(s) 122 can be a plurality of flattened images representing one or more viewpoints of the 3D model 112. For instance, a cube map 122 can include a plurality of 2D cube side images such as a front 2D cube side image, a left 2D cube side image, a right 2D cube side image, a rear 2D cube side image, a top 2D cube side image, and a bottom 2D cube side image. These 2D cube side images can be generated by the environment generator engine 104 to provide a supplemental lower resolution option for generating the 3D space 106. The environment generator engine 104 can generate and/or store the cube map(s) 122 as the plurality of 2D cube side images with the association to the plurality of viewpoints (e.g., representing a navigable path through the 3D space, or a portion of the 3D space) and can retrieve the cube map version of the computer-generated 3D space in response to determining a CPU or RAM of the display device does not meet a threshold and/or experienced a reduction. Additionally or alternatively, a environment creator user interface (UI) 124 can present a option (e.g., an interactive togglable feature) for selecting whether to present the computer-generated 3D space 106 and/or portions of the (e.g., particular rooms or areas of the computer-generated 3D space 106) as cube maps 122 or as a full 3D rendering of the 3D model 112 or portions of the 3D model 112. The environment generator engine 104 can store multiple cube maps 122 at different resolutions corresponding to the single viewpoint and/or the plurality of viewpoints, which can be selected for presentation based on detecting the computation capabilities of the display device (e.g., a graphics card specification) and/or based on user input selecting the level of resolution. Accordingly, the environment generator engine 104 can be customizable to match available computing resources by retrieving higher or lower resolution cube maps 122 and/or portions of cube maps 122 (e.g., one or more 2D cube side images) to supplement and/or replace the 3D model 112 and/or portions of the 3D model 112 being rendered.

In some examples, the environment creator UI 124 can be used to customize, modify, or change various parameters of the environment generator engine 104 for creating the computer-generated 3D space 106. The one or more inputs can be provided at a drop down menu to select a type of scene model, such as a fully navigable 3D scene, a cube map-based scene with incremented viewpoints, or a combination of both. Additionally or alternatively, the one or more inputs at the environment creator UI 124 can provide the 3D model 112 to a file uploader; select or modify the environment boundary shape 118; or specify a type of lighting. For instance, the environment creator UI 124 can receive an input selecting an ambient light for the 3D space 106 that illuminates the entire 3D model 112, a particular light color and/or intensity, directional light which can illuminate a portion or sub region of the 3D model 112, and/or combinations thereof. Furthermore, the environment creator UI 124 can receive one or more inputs causing the environment generator engine 104 to set one or more scene controls, such as a navigational angle limit (e.g., an angle limit for looking up or down), a start angle, and/or a start zoom level. The inputs to the environment creator UI 124 can also provide the product data (e.g., product details, specifications, price information, videos, photos, shipping information, review, and so forth), the product models or images, and/or product locations mapped to the 3D model 112 (e.g., via a drag-and-drop feature).

In some scenarios, the environment generator engine 104 is particularized for a certain type of entity using the environment generator engine 104. For instance, a first set of environment parameters can be locked as static/immutable and/or a second set of environment parameters can be dynamic parameters that can be changed, modified, and/or toggled at the merchant level or the guest level. The virtual environment platform 102 can define the locked environment parameters and/or the dynamic environment parameters to correspond to a use case, product type, or presentation style unique to the entity using the environment generator engine 104 to present their products. Additionally or alternatively, the locked environment parameters and/or the dynamic environment parameters can correspond to device settings of the entity using the environment generator engine 104 (e.g., the merchant systems 202 in FIG. 2) and/or device settings of the guest devices (e.g., the guest systems 204 in FIG. 2).

In some instances, by using the techniques discussed herein to combine the 3D model(s) 112 with the surface customization(s) 118, product model(s) 120, and/or cube map(s) 122, the environment generator engine 104 can render the computer-generated 3D space 106 in an efficient manner using minimal computational resources. and/or can be rotatable with a zoom in and/or zoom out feature using a mouse input device, arrow keys, a tracker, and/or a touchscreen associated with the display 114 presenting the computer-generated 3D space 106. Additionally, the computer-generated interactive 3D space can be navigable by the avatar 110 with complete freedom of continuous movement in any direction while providing a high level of detail and multiple engaging features.

Furthermore, the virtual environment platform 102 can include an avatar customization UI 126 for selecting or changing settings of the avatar customization engine 108. A button or other interactive UI feature can be selected to cause the virtual environment platform 102 to present the avatar customization UI 126 from the environment creation UI 124, or from another UI of the virtual environment platform 102. In some examples, the avatar customization engine 108 can have a set of mutable customization parameter(s) 128 (e.g., adjustable with the avatar customization UI 126) and/or a set of immutable customization parameter(s) 130. Which parameters of the avatar's appearance fall into the set of mutable customization parameter(s) 128 or the set of immutable customization parameter(s) 130 can be based on an avatar template profile 132. The avatar template profile 132 can be associated with a particular entity (e.g., a particular merchant) and/or device(s) accessing the computer-generated 3D space 106 associated with the particular entity. A first entity can be associated with a first avatar template profile 132 corresponding to a type of entity of the first entity. For instance, the first entity type can be a cosmetics merchant type of entity, and the first avatar template profile 132 for this entity can define the mutable customization parameter(s) 128 to include one or more of makeup location, makeup styles, makeup colors, facial features, hairstyles, body type, skin tones, outfit style, outfit color,. Additionally or alternatively, the first avatar template profile 132 can define the immutable customization parameter(s) 130 to include one or more of a body shape or a degree of realism. Furthermore, a second entity can be associated with a second avatar template profile 132 corresponding to the type of entity of the second entity, such as a clothing merchant entity type. In some scenarios, the second avatar template profile 132 for this entity can define the mutable customization parameter(s) 128 to include one or more of body shape, skin tone, or facial features. Additionally or alternatively, the second avatar template profile 132 can define the immutable customization parameter(s) 130 to include a makeup style or a degree of realism. As such, the different avatar template profiles 132 associated with the different entities or entity types can have different style parameters defined as mutable or immutable, with some style parameters being mutable for some avatar template profiles 132 for some companies, and being immutable for other avatar template profiles 132 of other companies.

In some instances, the particular avatar template profile 132 for a particular entity can define the avatar parameters as mutable or immutable to correspond to a visual style of the entity in a computationally efficient and stylistically effective manner. Some entities may have a realism parameter defining how realistic the avatars look (e.g., photorealistic, or blocky/animated). The realism parameter can be immutable, such that all avatars 110 generated for that entities computer-generated 3D space 106 have a same degree of realism, yet can also be different between different avatar template profiles 132 for different entities, such that some entities provide an ability to generate realistic looking avatars 110, while other entities provide an ability to generate animated, blocky, or cartoony looking avatars 110 in their virtual environments. Furthermore, the mutable customization parameter(s) 128 or the immutable customization parameter(s) 130 can include features provided to the avatar customization engine 108 by the creator of the computer-generated 3D space 106, such as product model(s) 120 or product data. For instance, the first entity being a cosmetics merchant entity type can upload product data (e.g., cosmetics product data) to be included as a selectable or mutable style parameter for creating the avatar 110. In this way, guests of the computer-generated 3D space 106 created by the first entity can choose to add cosmetic products of the first entity to their avatar 110. Moreover, the second entity being the clothing merchant entity type can upload product data (e.g., clothing product data) to be included as a selectable or mutable style parameter for creating the avatar 110. In this way, guests of the computer-generated 3D space 106 created by the second entity can choose to add clothing products of the second entity to their avatar 110.

In some scenarios, the determination of which visual aspects of the avatar 110 are mutable or immutable can reflect a type of product, a style profile, or other brand feature associated with the entity or merchant generating/hosting the computer-generated 3D space 106. Accordingly, the virtual environment platform 102 can provide multiple different avatar customization UIs 126 to different entities creating their customized virtual environments with varying degrees and aspects of customization. Avatars 110 created by the avatar customization engine 108, and parameters or features associated with customized avatars 110, can be stored as browser cookies at a device of the guest systems. Additionally or alternatively, this avatar data can be stored or integrated with a login system of the merchant device (e.g., a merchant server).

Furthermore, in some instances, the avatar customization engine 108 can be presented in response to an interaction with a product model(s) 120 in the computer-generated 3D space 106. The avatar customization engine 108 can present an option for the user to apply the product represented by the product model(s) 120 to the visual appearance of the avatar 110. For instance, in response to an interaction with a clothing or makeup product model 120 (e.g., a lipstick product model), the avatar customization engine 108 can present an option to apply a virtual version of the clothing or makeup product to the avatar 110. For instance, the avatar customization engine 108 can present an option to select a hue (e.g., of lipstick) to apply to the avatar 110 (e.g., with a “Try it on me” button), along with an option to add the product to a shopping account of the user (e.g., an “Add to bag” button), which can be presented simultaneously with the option to apply the the virtual version to the avatar 110. The avatar customization engine 108 can also present product data (e.g., videos, instructional videos, photos, product details, an option to view additional information, etc.) with the option to apply the virtual version to the avatar 110.

Turning to FIG. 2, an example system 200 for generating the environment generator engine 104 is depicted. The system 200 can include the virtual environment platform 102 in communication with one or more merchant system(s) 202 and/or guest systems 204, for instance, via one or more network(s) 206. As discussed in greater detail below, various data files can be sent between the virtual environment platform 102 and the merchant system(s) 202 and/or guest systems 204 to provide the computer-generated 3D space 106 customized for the particular merchant system 202. The example system 200 can be the same as or form at least a portion of the system 100 depicted in FIG. 1.

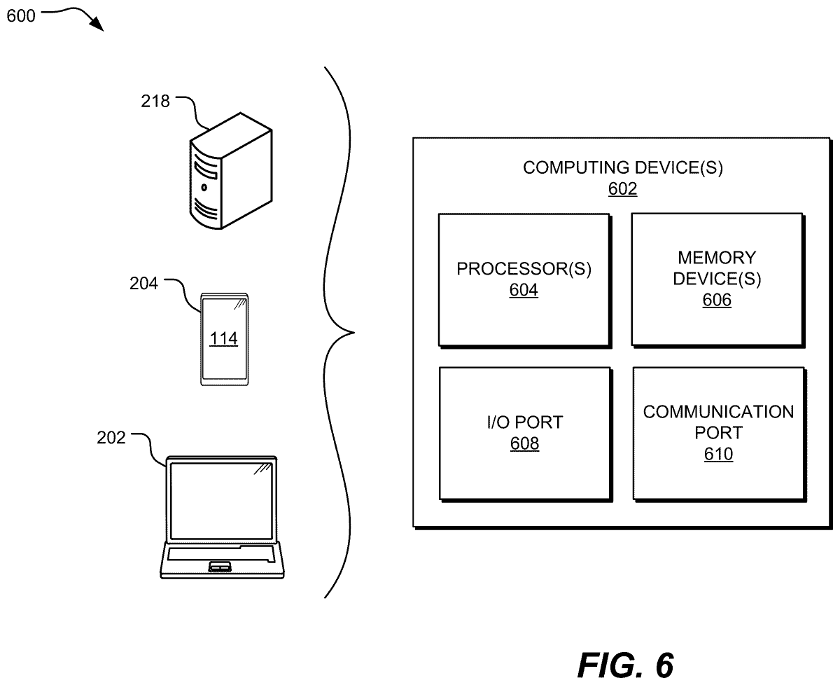

In some examples, the merchant system(s) 202 can be one or more computing devices (e.g., computing device(s) 602 discussed below regarding FIG. 6) associated with and/or located at a merchant entity (e.g., a cosmetic merchant type entity, a clothing merchant type entity, a jewelry merchant type entity, a consumer electronics type entity, a retailer type entity, a shoe type entity, a luxury brand type entity, a food brand type entity, a media or television type entity, etc.), such as server devices, desktop computers, mobile devices, etc. The merchant system(s) 202 can interact with the virtual environment platform 102 by establishing a network connection with the virtual environment platform 102 via the network(s) 206 and/or downloading data files from the virtual environment platform 102. The merchant system 202 can include the environment creator UI 124 which can be presented at the devices of the merchant system(s) 202 (e.g., via a first web portal) for providing information to merchant personnel, and/or to receive input from the merchant system(s) 202 dictating the parameters of the environment generator engine 104 for creating the computer-generated 3D space 106.

Additionally, in some instances, the merchant system(s) 202 can include (e.g., store and/or upload) product data 208 related to the merchant, such as the product model(s) 120 and/or other related information (e.g., product specifications, product price, product reviews, additional product models 120 or images, and the like). The product data 208 can be sent from the merchant system(s) 202 to the environment generator engine 104 via the network(s) 206 (e.g., by manually uploading and/or via one or more API calls). For instance, the product data 208 can update periodically (e.g., hourly, daily, weekly, seasonally, etc.) from a product information feed of the merchant system(s) 202. The product information can include one or more comma-separated values (CSV) files.

The system 200 can also comprise the guest system(s) 204. The guest systems 204 can include one or more user devices (e.g., the computing system 602 depicted in FIG. 6) for accessing and interacting with the computer-generated 3D space 106. The avatar customization UI 126 can be presented at the device(s) of the guest systems 204, for receiving one or more user input(s) 210 to customize the avatar 110. The user inputs 210 at the guest system 204 can select features to form the avatar 110 from the mutable customization parameter(s) 128. Additionally, the user inputs 210 received at the guest systems 204 can be used to navigate the computer-generated 3D space 106 with the avatar, zoom in or out, change a viewing angle, and/or interact (e.g., select, hover over, etc.) with the product models 120 mapped into the computer-generated 3D space 106.

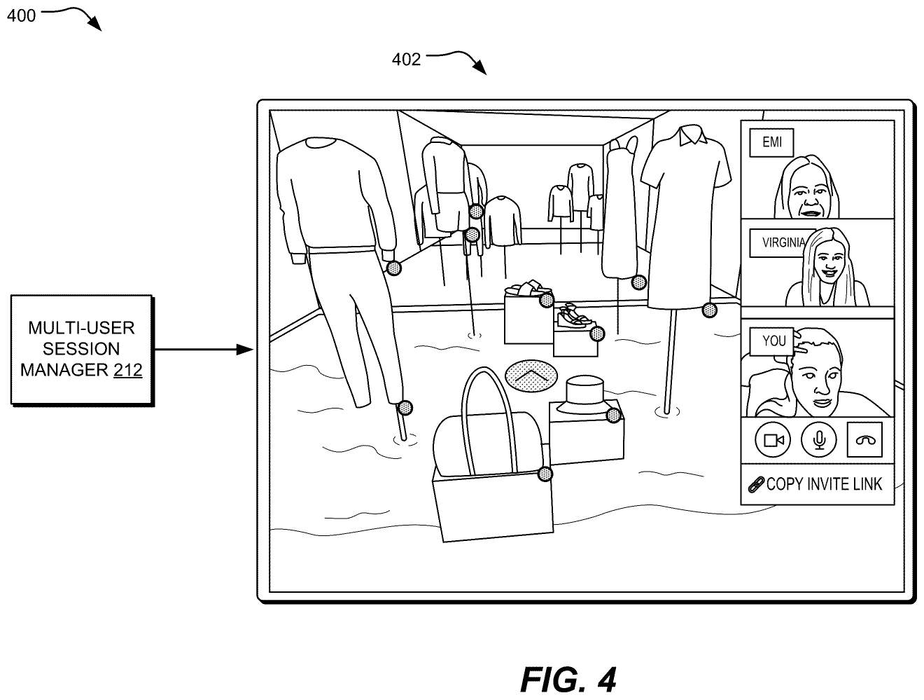

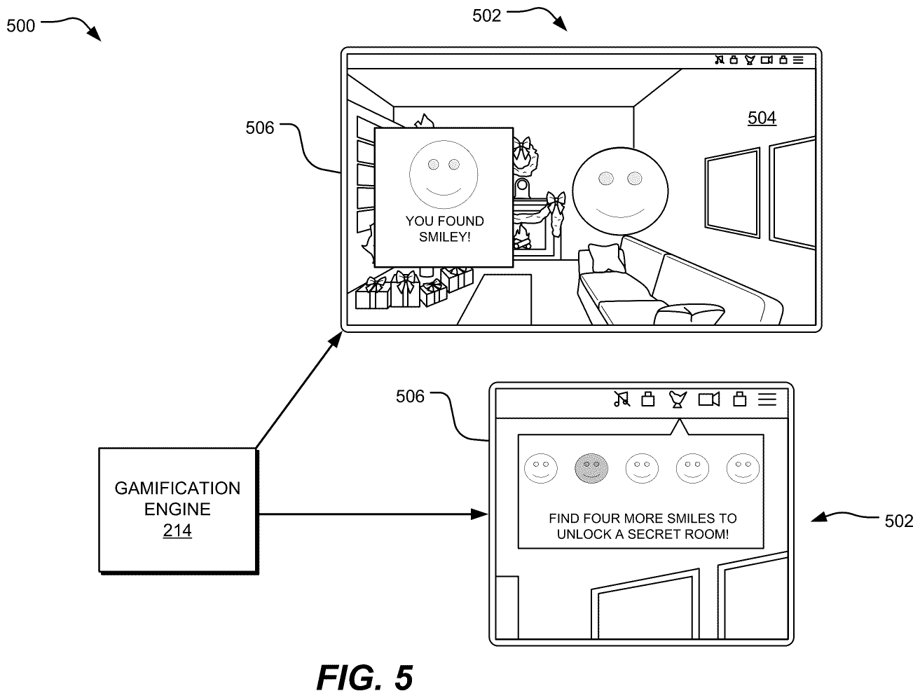

Moreover, in some scenarios the virtual environment platform 102 includes a multi-user session manager 212 for facilitating multi-user sessions at the computer-generated 3D space 106 (e.g., a “friend mode” or a “shopping with influencers mode”). For instance, a primary user of first guest system(s) 204 can select an interactive element presented at the display 114 (e.g., at a user interface of the computer-generated 3D space 106) to initiate the multi-user session and/or generate an access link for the multi-user session. The access link can be sent to other devices of other guest systems 204 to give the other guest systems 204 access to the computer-generated 3D space 106, as discussed in greater detail below regarding FIG. 4. Furthermore, in some examples, the virtual environment platform 102 includes a gamification engine 214. The gamification engine can be used to generate a gamification layer and add the gamification layer to the computer-generated 3D space 106, as discussed below regarding FIG. 5.

In some scenarios, the virtual environment platform 102, the merchant system(s) 202 and/or the guest systems 204 can communicate with each other via network connections provided by the network(s) 206. The network(s) 206 can include any type of network, such as the Internet, an intranet, a Local Area Network (LAN), a Wide Area Network (WAN), a Virtual Private Network (VPN), a Voice over Internet Protocol (VoIP) network, a wireless network (e.g., Bluetooth), a cellular network (e.g., 4G, LTE, 5G, etc.), satellite, combinations thereof, etc. The network 206 can include a communications network with numerous components such as, but not limited to gateways routers, servers, and registrars, which enable communication across the network 206. In one implementation, the communications network(s) includes multiple ingress/egress routers, which may have one or more ports, in communication with the network 206. Communication via any of the networks can be wired, wireless, or any combination thereof.

In some examples, the virtual environment platform 102 includes one or more databases 216 for storing the data files and/or software instructions discussed herein. The virtual environment platform 102 can also include one or more server devices 218 for performing operations of the virtual environment platform 102 (e.g., by accessing the data stored in the one or more databases 216 and/or executing algorithms). The one or more databases 216 and/or the one or more server devices 218 can form at least a portion of a third-party system or provider of the virtual environment platform 102 (e.g., separate from the merchant system 202 and the guest systems 204). Additionally or alternatively, the database(s) 216 and/or server device(s) 218 can be implemented as at least part of the merchant system(s) 202 or guest system(s) 204.

Furthermore, the various engines and UIs discussed herein can be retrieved from the one or more databases 216 to present at the merchant system(s) 202 or guest system(s) 204. In some examples, the one or more server devices 218 can host the environment generator engine 104 as a web portal using data stored at the one or more databases 216, such that any guest systems 204 accessing the web portal can access the computer-generated 3D space 106. The one or more server devices 218 may be a single server, a plurality of servers with each such server being a physical server or a virtual machine, or a collection of both physical servers and virtual machines. In another implementation, a cloud service hosts one or more components of the system 200. The one or more server devices 218 may represent an instance among large instances of application servers in a cloud computing environment, a data center, or other computing environment.

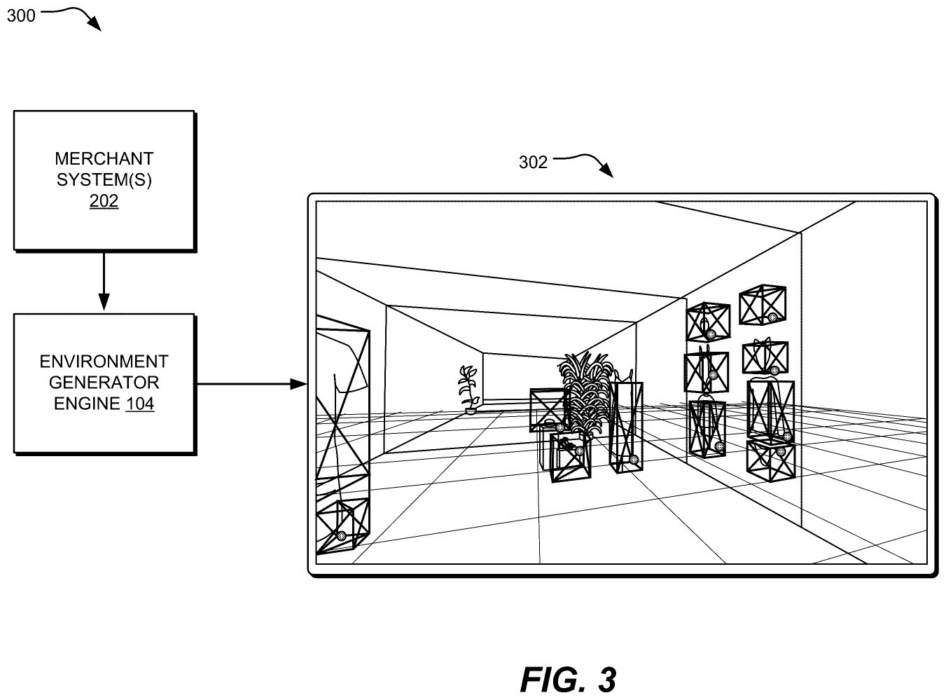

Turning to FIG. 3 an example system 300 to provide the computer-generated 3D space 106 with the virtual environment platform 102 is depicted. As depicted in FIG. 3, the system 300 can use the environment generator engine 104 to convert multiple inputs from the merchant system 202 into the computer-generated 3D space 106. The system 300 can be the same as or form at least a portion of the system 100 depicted in FIG. 1.

In some examples, the environment generator engine 104 can provide a mapping coordinate layer 302 onto the virtual surfaces of the rendered 3D model 112. The mapping coordinate layer 302 can comprise a plurality of 3D mapping coordinates corresponding to specific locations, surfaces, or features in the 3D model 112. Furthermore, using the environment creator UI 124, the merchant system(s) 202 can receive one or more inputs selecting one or more of the 3D mapping coordinates for placement of the product model(s) 120. For instance, one or more product model(s) 120 can be dragged and dropped onto a visual representation of the computer-generated 3D space 106 at one or more locations. The 3D mapping coordinates corresponding to these locations can be associated with the product model(s) 120, such that the product model(s) 120 are retrieved and rendered at the locations of the 3D mapping coordinates upon rendering the 3D model 112.

In some instances, the 3D model 112 represents a virtual structure such as a virtual building. The computer-generated 3D space 106 can be an exterior and/or an inside of the virtual building. For instance, the computer-generated 3D space 106 can include one or more rooms in the virtual building. In some scenarios, the virtual environment platform 102 can receive one or more inputs to customize a portion of the computer-generated 3D space 106, for instance, to personalize one of the rooms of the virtual building. The environment generator engine 104 can receive one or more inputs from the merchant system 202 to personalize the room for a particular user (e.g., a particular identifier associated with the guest system 204 or the guest device). By way of example, the customized room can include a customized message, customized product model(s) 120, a customized lighting theme or style theme, or the like, which can be layered over the 3D model 112 responsive to determining that the particular guest device (e.g., or avatar 110 associated with the particular guest device) is navigating the computer-generated 3D space 106 and/or logged into the virtual environment.

FIG. 4 illustrates an example system 400 to provide the computer-generated 3D space 106 with the virtual environment platform 102 using the multi-user session manager 212 to facilitate a multi-user session 402. The system 400 can be the same as or form at least a portion of the system 100 depicted in FIG. 1.

In some instances, the multi-user session manager 212 can define a particular user (e.g., a particular guest system 204) as a primary user, for instance, in response to receiving user input to initiate the multi-user session 402 from that user. A user interface to set parameters for the multi-user session 402 can be presented at the display of the primary user. For instance, the multi-user session manager 212 can receive one or more inputs to set a start/end date or time of the multi-user session 402, select or identify an assistant user and/or second user device with specialized access (e.g., to act as a guide and/or to interact with the primary user during the multi-user session 402), enter a name of the primary user, initiate a live-stream now, generate a copyable invitation link, add a message to the invitation link, set a minimum or maximum number of guests (e.g., secondary users), provide a contact or contact list to receive the invitation link with the message (e.g., using email and/or social media account integration), and/or send the invitation link and/or message. In some instances, the device associated with the primary user can present an indication that a secondary user has requested to join the session with an option to admit or deny entre, and/or with an indication of the number of available friend openings available for the session.

Furthermore, in some scenarios, the additional guest systems 204 receiving and clicking on the invitation link can be provided a prompt to provide a viewer name and agree to terms and conditions of participating in the multi-user session 402 prior to being granted access to the multi-user session 402. During the multi-user session 402, in some scenarios, the primary user navigates through the computer-generated 3D space 106 with a live audio channel being broadcast to the one or more secondary users, such that the secondary users can listen to the primary user talk and/or speak to the users or with the guide or assistant user. When the primary user selects a particular product model 120 and/or initiates a purchase related to the product model 120, the secondary users may be presented with a poll related to the product model and/or an option to add the product model to an account or shopping cart associated with the secondary user(s). Furthermore displays of the secondary users may present an option for toggling between a follow mode that shows the viewpoint of the primary user and a free exploration mode that gives the secondary user access to explore the computer-generated 3D space 106 or portion(s) of the 3D space 106 independently from the primary user. Moreover, during the multi-user session 402, the primary user can chat with the secondary users in the livestream, which can have a filtering feature to maintain the safety of the audience. Displays of the secondary users can present one or more video-in-videos of the computer-generated 3D space 106 of the primary user's perspective with a live video of the primary user's face, the secondary user's face, and/or the secondary user's perspective of the computer generated 3D space 106 (e.g., in the free exploration mode).

FIG. 5 illustrates an example system 500 to provide the computer-generated 3D space 106 with the virtual environment platform 102 using the gamification engine 214 to generate a gamification layer 502 in the computer-generated 3D space 106. The system 500 can be the same as or form at least a portion of the system 100 depicted in FIG. 1.

In some examples, the merchant system 202 can add or modify the gamification layer 502 by providing one or more inputs to a gamification UI presented at the display(s) 504 of the merchant device(s) 506. Example gamification layers 502 include a scavenger hunt layer in which items (e.g., smiley faces, coins, butterflies, jewels, etc.) are dispersed throughout the computer-generated 3D space 106 and users explore the 3D space attempting to find/collect the items. In some instances, a prompt or other type of content (e.g., video, animation, text, song, audio, or so forth) can be presented to the user device of the guest system 204 in response to find or selecting the item(s). The content can be retrieved from the product data 208 of the merchant system 202. Furthermore, a progress indicator can be displayed at the user device of the guest system 204, which can fill in with a color to indicate an amount of items found. In some instances, the item can be a static image (e.g., butterfly that transforms into an animation (e.g., the butterfly flying away) upon being found or selected. The inputs provided to the gamification UI at the merchant devices 506 can determine the characteristics of the gamification layer 502, such as an item image/animation, a customizable prize for completing the scavenger hunt (e.g., a discount, a free product, entry into a raffle, and so forth), a number of items to be found, locations of the items, or response messages/outputs for finding the items such as an uploaded animation (e.g., sparkles, a diamond animation, text, etc.).

FIG. 6 illustrates an example system 600 to provide the computer-generated 3D space 106 with the virtual environment platform 102. The system 600 can include one or more computer device(s) 602 which can implement the systems 100-500 and/or perform the methods discussed herein. In one implementation, the one or more computing device(s) 602 include the user devices of the merchant systems 202, the guest systems 204, the server device(s) 218, or any other devices discussed throughout this disclosure.

In some instances, the computing device(s) 602 includes a computer, a personal computer, a desktop computer, a laptop computer, a terminal, a workstation, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. It will be appreciated that specific implementations of these devices may be of differing possible specific computing architectures not all of which are specifically discussed herein but will be understood by those of ordinary skill in the art.

The computing device 602 may be a computing system capable of executing a computer program product to execute a computer process. The virtual environment platform 102 can be stored and executed at the computing device(s) 602 (e.g., as one or more software components, algorithm modules, or so forth). Data and program files may be input to the computing device 602 which reads the files and executes the programs therein to provide the various components of the virtual environment platform 102 and generate the computer-generated 3D space 106. Some of the elements of the computing device 602 include one or more hardware processors 604, one or more memory devices 606, and/or one or more ports, such as input/output (IO) port(s) 608 and communication port(s) 610. Additionally, other elements that will be recognized by those skilled in the art may be included in the computing device 602 but are not explicitly depicted in FIG. 6 or discussed further herein. Various elements of the computing device 602 may communicate with one another by way of the communication port(s) 610 and/or one or more communication buses, point-to-point communication paths, or other communication means.

The processor 604 may include, for example, a central processing unit (CPU), a microprocessor, a microcontroller, a digital signal processor (DSP), and/or one or more internal levels of cache. There may be one or more processors 604, such that the processor 604 comprises a single central-processing unit, or a plurality of processing units capable of executing instructions and performing operations in parallel with each other, commonly referred to as a parallel processing environment.

The computing device 602 may be a conventional computer, a distributed computer, or any other type of computer, such as one or more external computers made available via a cloud computing architecture. The presently described technology is optionally implemented in software stored on the data storage device(s) such as the memory device(s) 606, and/or communicated via one or more of the ports 608 and 610, thereby transforming the computing device 602 in FIG. 6 to a special purpose machine for implementing the operations of the virtual environment platform 102 providing the computer-generated 3D space.

The one or more memory device(s) 606 may include any non-volatile data storage device capable of storing data generated or employed within the computing device 602, such as computer executable instructions for performing a computer process, which may include instructions of both application programs and an operating system (OS) that manages the various components of the computing device 602. The memory device(s) 606 may include, without limitation, magnetic disk drives, optical disk drives, solid state drives (SSDs), flash drives, and the like. The memory device(s) 606 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 606 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 606 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 602 includes one or more ports, such as the I/O port 608 and the communication port 610, for communicating with other computing, network, or vehicle devices. It will be appreciated that the I/O port 608 and the communication port 610 may be combined or separate and that more or fewer ports may be included in the computing device 602.

The I/O port 608 may be connected to an I/O device, or other device, by which information is input to or output from the computing device 602. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 602 via the I/O port 608. Similarly, the output devices may convert electrical signals received from the computing device 602 via the I/O port 608 into signals that may be sensed as output by a human, such as sound, light, and/or touch. The input device may be an alphanumeric input device, including alphanumeric and other keys for communicating information and/or command selections to the processor 604 via the I/O port 608. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing device 602 via the I/O port 608. For example, an electrical signal generated within the computing device 602 may be converted to another type of signal, and/or vice-versa. In one implementation, the environment transducer devices sense characteristics or aspects of an environment local to or remote from the computing device 602, such as, light, sound, temperature, physical movement, orientation, acceleration, gravity, and/or the like. Further, the environment transducer devices may generate signals to impose some effect on the environment either local to or remote from the example computing device 602, such as, physical movement of some object (e.g., a mechanical actuator) and/or the like.

In one implementation, the communication port 610 is connected to the network 206 and the computing device 602 may receive network data useful in executing the methods and systems set out herein as well as transmitting information and network configuration changes determined thereby. Stated differently, the communication port 610 can connect the computing device 602 to one or more communication interface devices configured to transmit and/or receive information between the computing device 602 and other devices by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 610 to communicate one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 610 may communicate with an antenna or other link for electromagnetic signal transmission and/or reception.

In an example implementation, the virtual environment platform 102 may be embodied by instructions stored on the memory devices 606 and executed by the processor 604.

The system 600 set forth in FIG. 6 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 602.

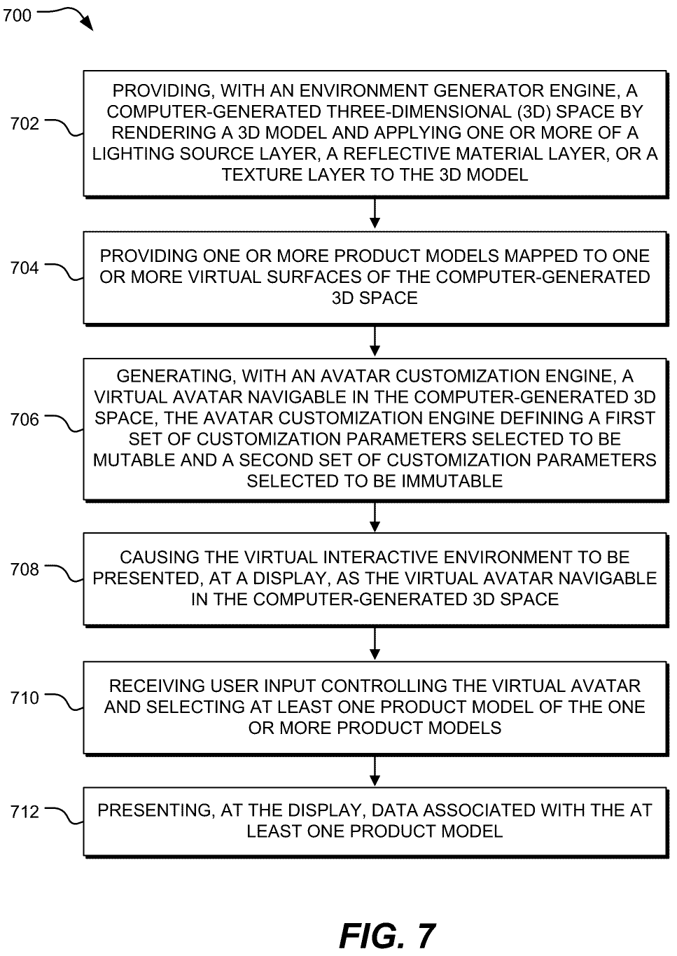

FIG. 7 illustrates an example method 700 to provide the computer-generated 3D space 106 using the virtual environment platform 102, which can be performed by any of the systems 100-600.

In some examples, at operation 702, the method 700 provides, with an environment generator engine, a computer-generated 3D space by rendering a 3D model and applying one or more of a lighting source layer, a reflective material layer, or a texture layer to the 3D model. At operation 704, the method 700 can provide one or more product models mapped to one or more virtual surfaces of the computer-generated 3D space. At operation 706, the method 700 can generate, with an avatar customization engine, a virtual avatar navigable in the computer-generated 3D space, the avatar customization engine defining a first set of customization parameters selected to be mutable and a second set of customization parameters selected to be immutable. At operation 708, the method 700 can cause the virtual interactive environment to be presented, at a display, as the virtual avatar navigable in the computer-generated 3D space. At operation 710, the method 700 can receive a user input controlling the virtual avatar and selecting at least one product model of the one or more product models. At operation 712, the method 700 can present, at the display, data associated with the at least one product model.

It is to be understood that the specific order or hierarchy of steps in the method 700 depicted in FIG. 7 or throughout this disclosure are instances of example approaches and can be rearranged while remaining within the disclosed subject matter. For instance, any of the operations depicted in FIG. 7 or throughout this disclosure may be omitted, repeated, performed in parallel, performed in a different order, and/or combined with any other of the operations depicted in FIG. 7 or throughout this disclosure.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method to provide a virtual interactive environment, the method comprising:
providing, with an environment generator engine, a computer-generated three-dimensional (3D) space by rendering a 3D model and applying one or more of a lighting source layer, a reflective material layer, or a texture layer to the 3D model;
providing one or more product models mapped to one or more virtual surfaces of the computer-generated 3D space;
generating, with an avatar customization engine, a virtual avatar navigable in the computer-generated 3D space, the avatar customization engine defining a first set of customization parameters selected to be mutable and a second set of customization parameters selected to be immutable;
causing the virtual interactive environment to be presented, at one or more displays, as the virtual avatar navigable in the computer-generated 3D space;
receiving user input controlling the virtual avatar to select at least one product model of the one or more product models; and
presenting, at the one or more display, data associated with the at least one product model.

2. The method of claim 1, further comprising presenting an environment creator user interface (UI) at the one or more displays, wherein providing the one or more product models includes:
providing one or more 3D mapping coordinates corresponding to virtual surfaces of the 3D model; and
receiving, at the environment creator UI, a selection of the one or more 3D mapping coordinates to designate locations for the one or more product models.

3. The method of claim 2, wherein receiving the selection of the one or more 3D mapping coordinates includes receiving a drag-and-drop input placing the one or more product models at the one or more 3D mapping coordinates.

4. The method of claim 2, wherein:
the environment creator UI includes a graphical interactive feature for toggling between a high resolution output and a low resolution output; and
in response to receiving a toggle input at the graphical interactive feature, the method further includes:
converting the 3D model into a plurality of cube maps corresponding to a plurality of viewpoints; and
providing the computer-generated three-dimensional (3D) space by rendering the plurality of cube maps instead of rendering at least a portion of the 3D model.

5. The method of claim 4, wherein providing the computer-generated 3D space includes:
applying the reflective material layer to the 3D model; and
providing an environment boundary shape, at least partially enclosing the 3D model, to create a sky visualization or a ceiling visualization with a surface of the environment boundary shape, the reflective material layer creating a reflection of the surface viewable from a perspective of the virtual avatar.

6. The method of claim 1, wherein the second set of customization parameters are selected to be immutable based on style parameters associated with a type of merchant entity.

7. The method of claim 6, wherein the second set of customization parameters selected to be immutable include one or more of a body shape or a degree of realism.

8. The method of claim 1, further comprising:
establishing a multi-user session in the virtual interactive environment; and
generating an invite link associated with the multi-user session for providing access to the multi-user session for a plurality of users.

9. The method of claim 8, further comprising presenting an option, responsive to the user input selecting the at least one product model in the multi-user session, for the plurality of users to add an item corresponding to the at least one product model to accounts associated with the plurality of users.

10. The method of claim 9, further comprising presenting an option to at least one user of the plurality of the users to switch between viewing a primary user navigating the computer-generated 3D space or navigating the computer-generated 3D space independent of the primary user.

11. A system for providing a virtual interactive environment, the system comprising:
one or more processors; and
a computer-readable memory device storing instructions that, when executed by the one or more processors, cause the system to:
provide an environment generator engine for generating a computer-generated three-dimensional (3D) space by rendering a 3D model and applying one or more surface customizations to the 3D model;
provide one or more product models mapped to one or more virtual surfaces of the 3D model;
provide an avatar customization engine for generating a virtual avatar navigable in the computer-generated 3D space, the avatar customization engine defining a first set of customization parameters selected to be mutable and a second set of customization parameters selected to be immutable;
cause the virtual interactive environment to be presented, at a display of a user device, as the virtual avatar navigable in the computer-generated 3D space;
receive user input controlling the virtual avatar and selecting at least one product model of the one or more product models; and
present, at the display, data associated with the at least one product model.

12. The system of claim 11, further comprising providing a gamification engine for layering a scavenger hunt type game or a tile matching type game into the computer-generated 3D space.

13. The system of claim 11, wherein:
the display is a first display; and
providing the environment generator engine includes presenting an environment creator user interface (UI) at second display of a merchant device, the environment creator UI receiving one or more inputs indicating at least one of:
a location of the one or more product models in the computer-generated 3D space;
a personalization of at least a portion of the computer-generated 3D space for a particular user;
a customized message in the computer-generated 3D space; or
a lighting theme for a portion of the computer-generated 3D space.

14. The system of claim 13, wherein the first set of customization parameters are mutable and the second set of customization parameters are immutable based on an avatar profile template associated with the merchant device.

15. The system of claim 14, wherein:
the avatar profile template is a first avatar profile template and the merchant device is a first merchant device of a first merchant entity;
the instructions, when executed by the one or more processors, further cause the system to provide the avatar customization engine to a second merchant device corresponding to a second merchant entity, the avatar customization engine defining a third set of customization parameters selected to be mutable and a fourth set of customization parameters selected to be immutable; and
the fourth set of customization parameters selected to be immutable correspond to a second avatar profile template associated with the second merchant entity, and the fourth set of customization parameters selected to be immutable are different than the second set of customization parameters selected to be immutable.

16. The system of claim 11, wherein the one or more surface customizations include at least one of a lighting source layer, a reflective material layer, or a texture layer.

17. The system of claim 11, wherein the environment generator engine generates the computer-generated 3D space by rendering one or more cube maps, based on the 3D model, in addition to rendering the 3D model.

18. The system of claim 11, wherein:
the instructions, when executed by the one or more processors, cause the system to present a graphical interactive element which, upon receiving a user input, establishes a multi-user session for the virtual interactive environment; and
the multi-user session includes an audio channel for:
receiving an audio signal as input at a first user device corresponding with primary user; and
sending the audio signal as output at a plurality of user devices corresponding with a plurality of secondary users.

19. A method to provide a virtual interactive environment, the method comprising:
providing, with an environment generator engine, a computer-generated three-dimensional (3D) space by rendering a 3D model and applying one or more of a lighting source layer, a reflective material layer, or a texture layer to the 3D model;
providing a creator user interface (UI) for mapping one or more product models to one or more virtual surfaces of the 3D model;
providing an avatar customization UI for generating, with an avatar customization engine, a virtual avatar navigable in the computer-generated 3D space;
causing the virtual interactive environment to be presented, at a display of a user device, as the virtual avatar navigable in the computer-generated 3D space;
receiving user input controlling the virtual avatar and selecting at least one product model of the one or more product models; and
presenting, at the display, data associated with the at least one product model.

20. The method of claim 19, wherein the avatar customization engine defines a first set of customization parameters selected to be mutable and a second set of customization parameters selected to be immutable.
